(19) United States
(12) Patent Application Publication
(10) Pub. No.: US 2005/0028020 A1
(43) Pub. Date: Feb. 3, 2005

(54) Spread spectrum clocking for data transfer bus loading

(76) Inventors: Ryan Zarrieff, Meridian, ID (US); Vincent C. Skurdal, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/628,900

(22) Filed: Jul. 28, 2003

(51) Int. Cl. G06F 1/04

(52) U.S. Cl. 713/600

(57) ABSTRACT

In an implementation of spread spectrum clocking for data transfer bus loading, a frequency spread deviation for spread spectrum clocking of data transferred via a data transfer bus is adjusted according to operating conditions of a data control system, where the operating conditions correspond to data transfer bus loading.

### BACKGROUND

Spread spectrum clocking spreads the energy of a signal over a range of frequencies to dissipate the energy rather than having the signal concentrated at a particular constant frequency. Spread spectrum clocking can be accomplished by modulating the phase (e.g., dithering) the control clock timing of the signal. Spreading the energy of a signal over a range of frequencies can help to reduce electromagnetic interference emissions and noise associated with a signal that would otherwise be concentrated at one frequency.

Data transfer buses in computing devices, such as a data bus, address bus, control bus, and the like, communicate or transfer data between components in the computing device. For example, a microprocessor can be coupled to various memory devices via a memory bus. The number of devices that can be coupled to communicate via a data transfer bus at any one time is determined by bus loading which describes the limit of signal load capacity for a particular bus. Data transmissions that exceed the capacity of a data transfer bus can result in data transmission errors due to timing margin inaccuracies.

### BRIEF DESCRIPTION OF THE DRAWINGS

The same numbers are used throughout the drawings to reference like features and components:

FIG. 1 illustrates an exemplary data transfer circuit in which spread spectrum clocking for data transfer bus loading can be implemented.

FIG. 2 illustrates an exemplary control system in which spread spectrum clocking for data transfer bus loading can be implemented.

FIG. 3 illustrates a data transfer frequency chart that illustrates exemplary spread spectrum clocking for data transfer bus loading.

FIG. 4 is a flow diagram that illustrates an exemplary method for spread spectrum clocking for data transfer bus loading.

FIG. 5 illustrates various components of an exemplary printing device in which spread spectrum clocking for data transfer bus loading can be implemented.

FIG. 6 illustrates various components of an exemplary computing device in which spread spectrum clocking for data transfer bus loading can be implemented.

### DETAILED DESCRIPTION

The following describes systems and methods related to spread spectrum clocking for data transfer bus loading, such as when transferring or communicating data via a data transfer bus. A data transfer bus includes any one of a data bus, an address bus, a control bus, a memory bus, and the like. Spread spectrum clocking is implemented to minimize, or otherwise decrease, electromagnetic emissions associated with transferring data via a data transfer bus. This decreases the strength of a data signal at any one frequency for regulatory compliance of electromagnetic emissions limits for electronic products and devices. Controlling electromagnetic emissions can also alleviate the need for costly metal housings to shield the emissions of a device from other components, such as computer monitors, telephones, and the like.

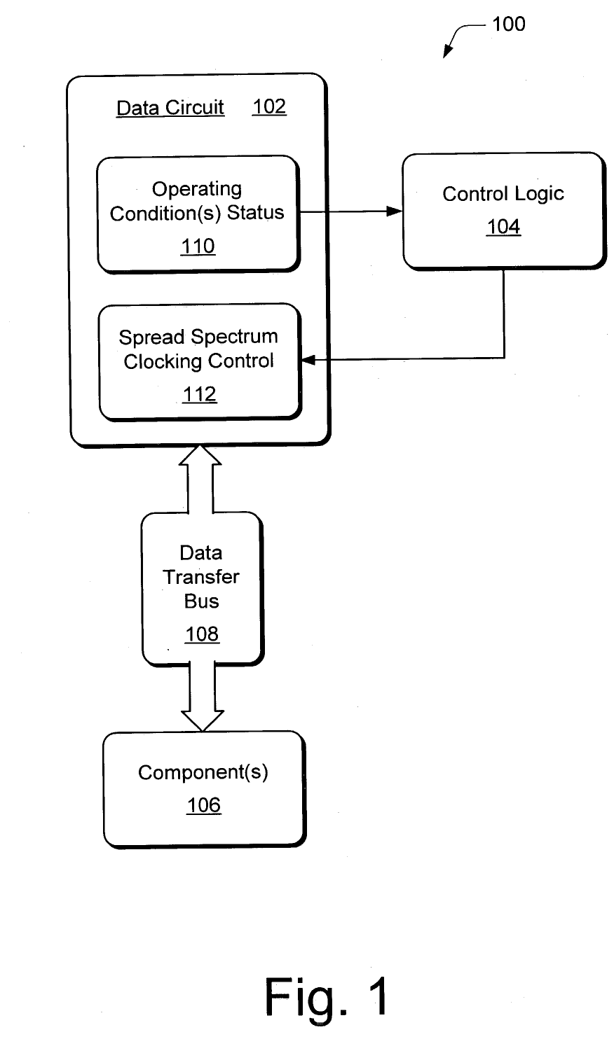

FIG. 1 illustrates an exemplary data transfer circuit 100 in which spread spectrum clocking for data transfer bus loading can be implemented. The data transfer circuit 100 includes a data circuit 102, control logic 104, one or more system components 106, and a data transfer bus 108 over which data circuit 102 communicates data with the one or more system components 106. Data transfer bus 108 can include any one or more of a data bus, an address bus, a control bus, a memory bus, and the like.

The data circuit 102 includes an operating condition(s) status 110 and a spread spectrum clocking control 112. The operating condition(s) status indicates operating condition(s) of the data circuit 102 and corresponds to data communications loading on the data transfer bus 108. The operating conditions can include any one of process, voltage, and/or temperature conditions of the data circuit 102.

A process variation can occur when the data circuit 102 is manufactured. For example, data circuit 102 can be an application-specific integrated circuit (ASIC) that has a manufactured silicon variance which affects data communications transfer and bus loading. Further, an increase in voltage applied to data circuit 102 will increase the data transfer speed, but will also increase the operating temperature which decreases the data transfer speed. Collectively, the process-voltage-temperature (PVT) operating conditions of data circuit 102 affect the bus loading and data transfer via data transfer bus 108.

The spread spectrum clocking control 112 controls a frequency spread deviation for data communication via data transfer bus 108. The spread spectrum clocking control 112 can be implemented as a phase-locked loop, for example, that dithers the frequency signal of a data communication. The frequency spread deviation of data communications can be controlled by adjusting a minimum clock frequency and a maximum clock frequency, or by adjusting a percentage clock frequency deviation from a center frequency. The minimum clock frequency and the maximum clock frequency define a dithering range to spread out the energy of the communicated data.

The control logic 104 can be implemented to obtain the operating condition(s) status 110 and generate an input to the spread spectrum clocking control 112 to adjust the frequency spread deviation of data communications according to the operating conditions status 110. The frequency spread deviation (e.g., spread spectrum clocking) can be adjusted to minimize, or otherwise decrease, electromagnetic emissions associated with data communications via data transfer bus 108. Spread spectrum clocking adjustment for data bus loading can be implemented for any type of data communication bus, such as a variable loading data transfer bus that has flexible loading parameters, to minimize electromagnetic emissions when operating conditions of the data circuit 102 are varied.

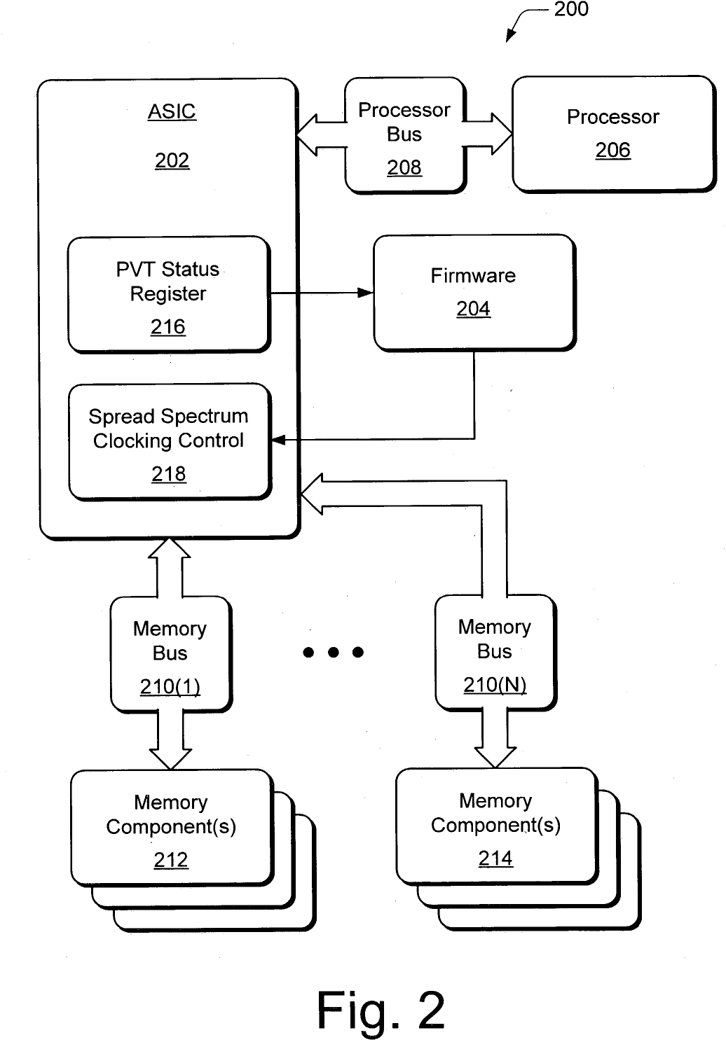

FIG. 2 illustrates an exemplary control system 200 in which spread spectrum clocking for data transfer bus loading can be implemented. The control system 200 includes an application-specific integrated circuit (ASIC) 202, firmware 204, a processor (or controller) 206, and a processor bus 208 over which the ASIC 202 transfers data to the processor 206. The control system 200 also includes any number of other data buses, such as memory buses 210(1), . . . , 210(N), and memory component(s) 212 and 214. The ASIC 202 can be implemented as a memory controller to transfer data to the memory components 212 and 214 via the memory buses 210(1) and 210(N), respectively.

The ASIC 202 includes a pressure-voltage-temperature (PVT) status register 216 and a spread spectrum clocking control 218. The PVT status register maintains a PVT status that indicates operating conditions of the ASIC 202 and corresponds to data loading on memory buses 210(1), . . . , 210(N). The spread spectrum clocking control 218 controls a frequency spread deviation for data transfer via a memory bus 210. The spread spectrum clocking control 218 controls the frequency spread deviation of data transfer by adjusting a minimum clock frequency and a maximum clock frequency, or by adjusting a percentage clock frequency deviation from a center frequency.

A memory bus 210 can be expandable and data loading on the bus can depend on any number of memory component 212 variables, such as the size and data transfer speed of a memory component. The ASIC 202 can include multiple strength drive pads which can be adjusted based on the PVT operating conditions of the ASIC 202, and to compensate for an additional load, or increase in data transfer. However, increasing the data transfer loading on a memory bus 210 may also increase the electromagnetic emissions associated with the increased data transfer.

The firmware 204 includes logic that can be implemented to obtain the PVT operating conditions status from the PVT register 216 and generate an input to the spread spectrum clocking control 218 to adjust the frequency spread deviation of data transfer according to the PVT status. The frequency spread deviation (e.g., spread spectrum clocking) can be adjusted to minimize, or otherwise decrease, the electromagnetic emissions associated with data transfer via a memory bus 210. For increased bus loading (e.g., data transfers on a memory bus 210), the frequency spread deviation can be adjusted to correspond to a drive pad strength setting. Accordingly, a maximum pad drive strength can correspond to a maximum frequency spread deviation, a nominal pad drive strength can correspond to a nominal frequency spread deviation, and so on. Not only does the ASIC drive pad strength correspond to memory bus loading, but a relationship is established between the memory bus loading and spread spectrum clocking.

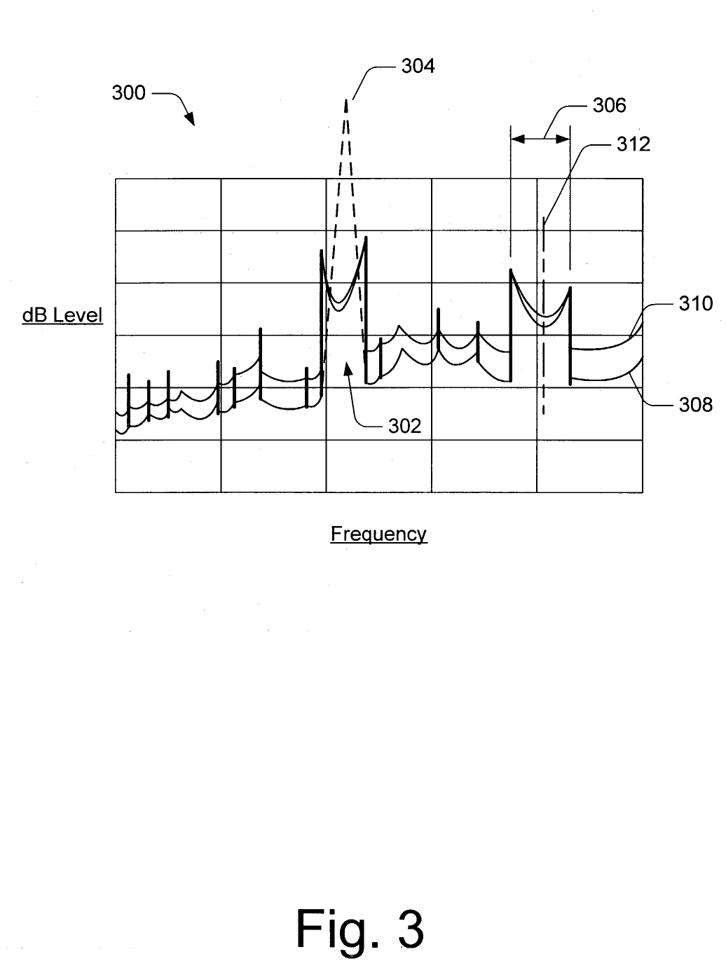

FIG. 3 illustrates a data transfer frequency chart 300 that illustrates exemplary spread spectrum clocking for data transfer bus loading. A peaked frequency pair 302 illustrates dithered clocks, or spread spectrum clocking of a frequency for a data signal. Without spread spectrum clocking of data transfer bus loading, all of the electromagnetic energy for the data signal would be concentrated at harmonics 304 (e.g., multiples of the fundamental frequency) in the frequency domain. A frequency spread deviation 306 can be controlled by adjusting a minimum clock frequency 308 and a maximum clock frequency 310 for data communication, or by adjusting a percentage clock frequency deviation from a center frequency 312.

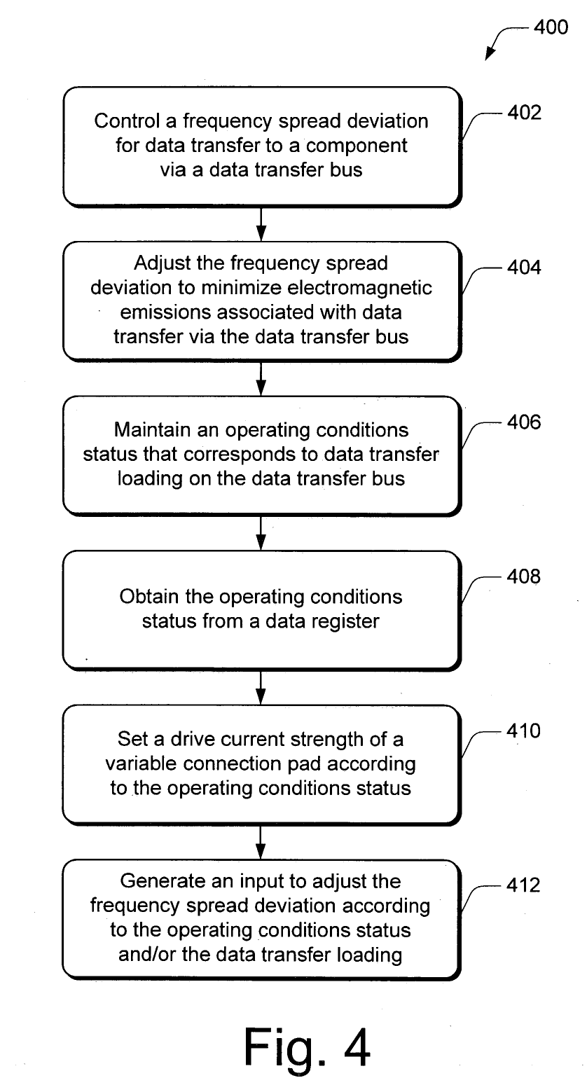

FIG. 4 illustrates an exemplary method 400 for spread spectrum clocking for data transfer bus loading. The order in which the method is described is not intended to be construed as a limitation, and any number of the described method blocks can be combined in any order to implement the method. Furthermore, the method can be implemented in any suitable hardware, software, firmware, or combination thereof. A method for spread spectrum clocking for data transfer bus loading may also be described in the general context of computer executable instructions. Generally, computer executable instructions include routines, programs, objects, components, data structures, and the like that perform particular function(s) or implement data type(s).

At block 402, a frequency spread deviation is controlled for data transfer to a component via a data transfer bus. For example, a frequency spread deviation 306 (FIG. 3) is controlled for data transfer to a memory component 212 (FIG. 2) via memory bus 210. The frequency spread deviation can be controlled with the spread spectrum clocking control 218 (e.g., a phase-locked loop) which receives an input to adjust the frequency spread deviation from firmware component 204.

At block 404, the frequency spread deviation is adjusted to minimize electromagnetic emissions associated with data transfer via the data transfer bus. For example, a minimum clock frequency 308 (FIG. 3) and/or a maximum clock frequency 310 can be adjusted to minimize the electromagnetic transmissions associated with data transfer via a memory bus 210 (FIG. 2). Alternatively, a percentage clock frequency deviation can be adjusted from a center frequency 312 for data transfer via a memory bus 210.

At block 406, an operating conditions status is maintained that corresponds to data transfer loading on the data transfer bus. The operating conditions status corresponds to at least one of a process, a voltage, and a temperature operating condition of the data circuit 102 (FIG. 1) or of the ASIC 202 (FIG. 2). This may include maintaining a process-voltage-temperature (PVT) status in the PVT status register 216 that corresponds to data transfer loading on a memory bus 210, where the PVT status indicates the operating conditions of the ASIC 202.

At block 408, the operating conditions status is obtained from a data register. For example, a PVT status corresponding to the ASIC 202 is obtained from PVT status register 216. At block 410, a drive current strength of a variable connection drive pad is set according to the operating conditions status. For example, a drive current strength of a variable connection drive pad of the ASIC 202 is set according to the PVT status obtained from the PVT status register 216.

At block 412, an input is generated to adjust the frequency spread deviation according to the operating conditions status and/or the data transfer loading. For example, firmware 204 (FIG. 2) generates an ASIC input to the spread spectrum clocking control 218 to adjust the frequency spread deviation for data transfer. Similarly, control logic 104 (FIG. 1) generates an input to the spread spectrum clocking control 112 to adjust the frequency spread deviation for data transfer.

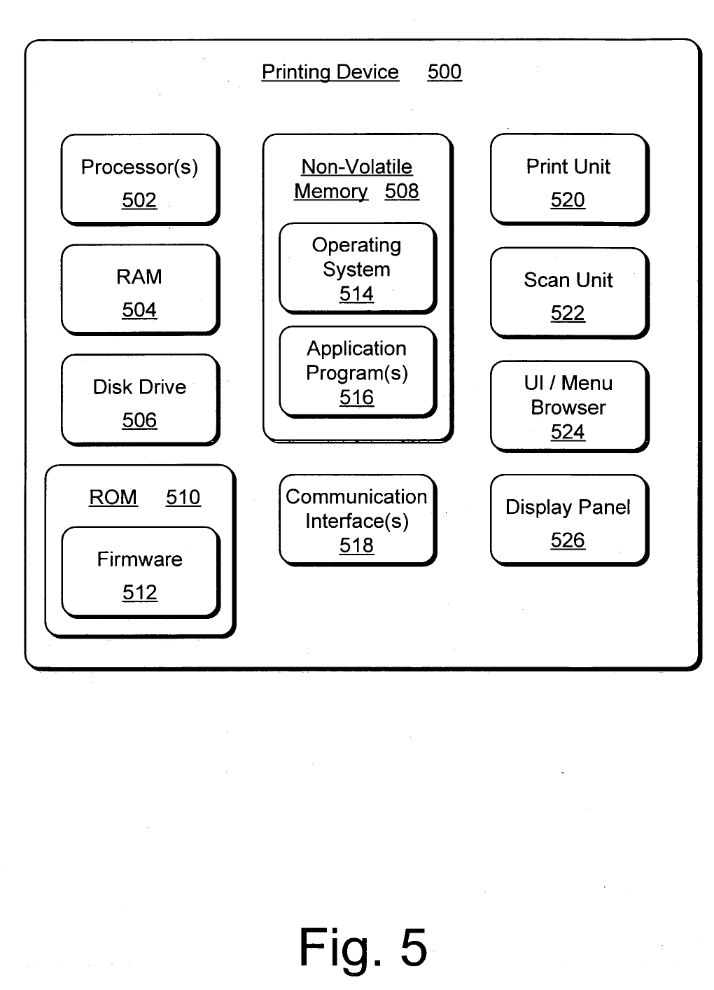

FIG. 5 illustrates various components of an exemplary printing device 500 in which spread spectrum clocking for data transfer bus loading can be implemented. General reference is made herein to one or more printing devices, such as printing device 500. As used herein, “printing device” means any electronic device having data communications, data storage capabilities, and/or functions to render printed characters, text, graphics, and/or images on a print media. A printing device may be a printer, fax machine, copier, plotter, and the like. The term “printer” includes any type of printing device using a transferred imaging medium, such as ejected ink, to create an image on a print media. Examples of such a printer can include, but are not limited to, inkjet printers, electrophotographic printers, plotters, portable printing devices, as well as all-in-one, multi-function combination devices.

Printing device 500 includes one or more processors 502 (e.g., any of microprocessors, controllers, and the like) which process various instructions to control the operation of printing device 500 and to communicate with other electronic and computing devices.

Printing device 500 can be implemented with one or more memory components, examples of which include random access memory (RAM) 504, a disk drive 506, and non-volatile memory 508 (e.g., any one or more of a ROM 510, flash memory, EPROM, EEPROM, etc.). The one or more memory components store various information and/or data such as configuration information, print job information and data, graphical user interface information, fonts, templates, menu structure information, and any other types of information and data related to operational aspects of printing device 500.

Printing device 500 includes a firmware component 512 that is implemented as a permanent memory module stored on ROM 510, or with other components in printing device 500, such as a component of a processor 502. Firmware 512 is programmed and distributed with printing device 500 to coordinate operations of the hardware within printing device 500 and contains programming constructs used to perform such operations.

An operating system 514 and one or more application programs 516 can be stored in non-volatile memory 508 and executed on processor(s) 502 to provide a runtime environment. A runtime environment facilitates extensibility of printing device 500 by allowing various interfaces to be defined that, in turn, allow application programs 516 to interact with printing device 500.

Printing device 500 further includes one or more communication interfaces 518 which can be implemented as any one or more of a serial and/or parallel interface, a wireless interface, any type of network interface, and as any other type of communication interface. A wireless interface enables printing device 500 to receive control input commands and other information from an input device, such as from an infrared (IR), 802.11, Bluetooth, or similar RF input device. A network interface provides a connection between printing device 500 and a data communication network which allows other electronic and computing devices coupled to a common data communication network to send print jobs, menu data, and other information to printing device 500 via the network. Similarly, a serial and/or parallel interface provides a data communication path directly between printing device 500 and another electronic or computing device.

Printing device 500 also includes a print unit 520 that includes mechanisms arranged to selectively apply an imaging medium such as liquid ink, toner, and the like to a print media in accordance with print data corresponding to a print job. The print media can include any form of media used for printing such as paper, plastic, fabric, Mylar, transparencies, and the like, and different sizes and types such as 8½×11, A4, roll feed media, etc.

Printing device 500, when implemented as an all-in-one device for example, can also include a scan unit 522 that can be implemented as an optical scanner to produce machine-readable image data signals that are representative of a scanned image, such as a photograph or a page of printed text. The image data signals produced by scan unit 522 can be used to reproduce the scanned image on a display device or with a printing device.

Printing device 500 also includes a user interface and menu browser 524 and a display panel 526. The user interface and menu browser 524 allows a user of printing device 500 to navigate the device's menu structure. User interface 524 can be indicators or a series of buttons, switches, or other selectable controls that are manipulated by a user of the printing device. Display panel 526 is a graphical display that provides information regarding the status of printing device 500 and the current options available to a user through the menu structure.

Although shown separately, some of the components of printing device 500 can be implemented in an application specific integrated circuit (ASIC). Additionally, a system bus (not shown) typically connects the various components within printing device 500. A system bus can be implemented as one or more of any of several types of bus structures, including a memory bus or memory controller, a peripheral bus, an accelerated graphics port, or a local bus using any of a variety of bus architectures.

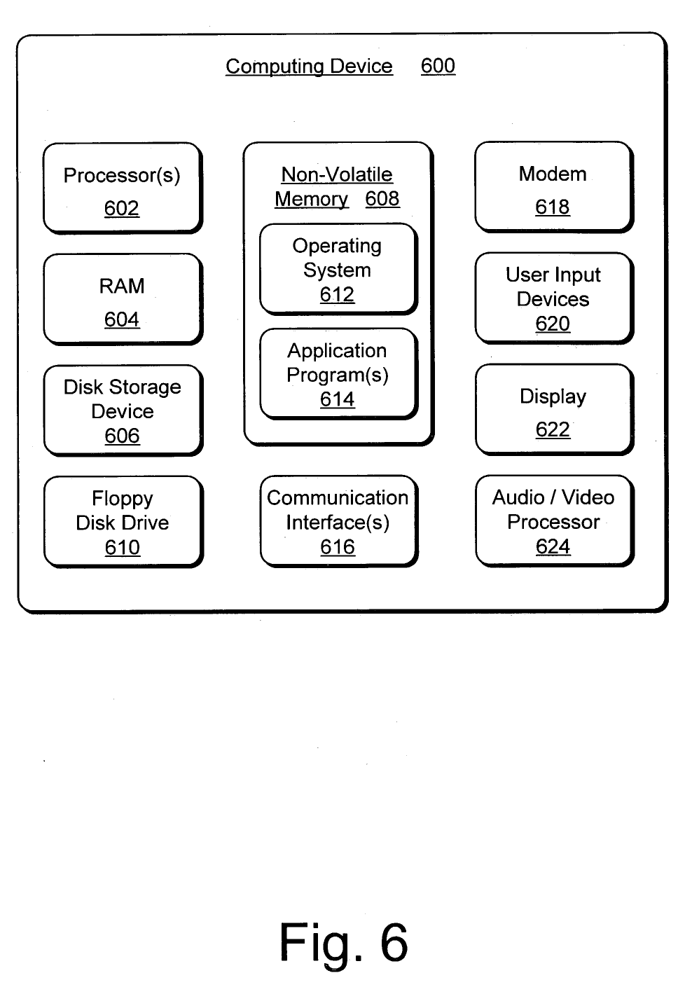

FIG. 6 illustrates an exemplary computing device 600 in which spread spectrum clocking for data transfer bus loading can be implemented. Computing device 600 includes one or more processors 602 (e.g., any of microprocessors, controllers, and the like) which process various instructions to control the operation of computing device 600 and to communicate with other electronic and computing devices. Computing device 600 can be implemented with one or more memory components, examples of which include a random access memory (RAM) 604, a disk storage device 606, non-volatile memory 608 (e.g., any one or more of a read-only memory (ROM), flash memory, EPROM, EEPROM, etc.), and a floppy disk drive 610.

Disk storage device 606 can include any type of magnetic or optical storage device, such as a hard disk drive, a magnetic tape, a recordable and/or rewriteable compact disc (CD), a DVD, DVD+RW, and the like. The one or more memory components provide data storage mechanisms to store various information and/or data such as configuration information for computing device 600, graphical user interface information, and any other types of information and data related to operational aspects of computing device 600. Alternative implementations of computing device 600 can include a range of processing and memory capabilities, and may include any number of differing memory components than those illustrated in FIG. 6.

An operating system 612 and one or more application program(s) 614 can be stored in non-volatile memory 608 and executed on processor(s) 602 to provide a runtime environment. A runtime environment facilitates extensibility of computing device 600 by allowing various interfaces to be defined that, in turn, allow the application programs 614 to interact with computing device 600. The application programs 614 can include a browser to browse the Web (e.g., “World Wide Web”), an email program to facilitate electronic mail, and any number of other different application programs.

Computing device 600 further includes one or more communication interfaces 616 and a modem 618. The communication interfaces 616 can be implemented as any one or more of a serial and/or parallel interface, as a wireless interface, any type of network interface, and as any other type of communication interface. A wireless interface enables computing device 600 to receive control input commands and other information from an input device, such as from a remote control device or from another infrared (IR), 802.11, Bluetooth, or similar RF input device.

A network interface provides a connection between computing device 600 and a data communication network which allows other electronic and computing devices coupled to a common data communication network to communicate information to computing device 600 via the network. Similarly, a serial and/or parallel interface provides a data communication path directly between computing device 600 and another electronic or computing device. Modem 618 facilitates computing device 600 communication with other electronic and computing devices via a conventional telephone line, a DSL connection, cable, and/or other type of connection.

Computing device 600 may include user input devices 620 that can include a keyboard, mouse, pointing device, and/or other mechanisms to interact with, and to input information to computing device 600. Computing device 600 also may include an integrated display device 622, such as for a potable computing device and similar mobile computing devices.

Computing device 600 also includes an audio/video processor 624 that generates display content for display on the display device 622, and generates audio content for presentation by a presentation device, such as one or more speakers (not shown). The audio/video processor 624 can include a display controller that processes the display content to display corresponding images on the display device 622. A display controller can be implemented as a graphics processor, microcontroller, integrated circuit, and/or similar video processing component to process the images. Video signals and audio signals can be communicated from computing device 600 to an external display via an RF (radio frequency) link, S-video link, composite video link, component video link, or other similar communication link.

Although shown separately, some of the components of computing device 600 may be implemented in an application specific integrated circuit (ASIC). Additionally, a system bus (not shown) typically connects the various components within computing device 600. A system bus can be implemented as one or more of any of several types of bus structures, including a memory bus or memory controller, a peripheral bus, an accelerated graphics port, or a local bus using any of a variety of bus architectures.

Although spread spectrum clocking for data transfer bus loading has been described in language specific to structural features and/or methods, it is to be understood that the subject of the appended claims is not necessarily limited to the specific features or methods described. Rather, the specific features and methods are disclosed as exemplary implementations of spread spectrum clocking for data transfer bus loading.

1. A control system, comprising:
a data circuit configured to communicate computer readable data with a component via a data transfer bus;
a control circuit configured to control a frequency spread deviation for data communication via the data transfer bus;
a data register configured to maintain an operating conditions status of the data circuit, the operating conditions status corresponding to data communications loading on the data transfer bus;
control logic configured to:
obtain the operating conditions status from the data register; and
generate a control circuit input to adjust the frequency spread deviation according to the operating conditions status.

2. A control system as recited in claim 1, wherein the control circuit is a phase-locked loop configured to receive the control circuit input and adjust the frequency spread deviation.

3. A control system as recited in claim 1, wherein operating conditions of the data circuit include at least one of a process, a voltage, and a temperature operating condition.

4. A control system as recited in claim 1, wherein the control circuit is further configured to control the frequency spread deviation by adjusting a minimum clock frequency and a maximum clock frequency for data communication.

5. A control system as recited in claim 1, wherein the control circuit is further configured to control the frequency spread deviation by adjusting a percentage clock frequency deviation from a center frequency for data communication.

6. A control system as recited in claim 1, further comprising an application specific integrated circuit (ASIC) that includes the data circuit, the control circuit, and the data register.

7. A control system as recited in claim 6, wherein:
the component is a memory component;
the data transfer bus is a memory bus; and
the data circuit is further configured to communicate the computer readable data to the memory component via the memory bus.

8. A control system as recited in claim 6, wherein the ASIC further includes variable connection drive pads, and wherein operating conditions of the ASIC include process, voltage, and temperature operating conditions.

9. A control system as recited in claim 6, wherein the ASIC further includes variable connection drive pads, and wherein operating conditions of the ASIC vary according to a drive current strength of a variable connection drive pad.

10. A control system as recited in claim 1, wherein the control logic is implemented as firmware in the control system.

11. A control system as recited in claim 1, wherein the control logic is further configured to generate the control circuit input to adjust the frequency spread deviation to minimize electromagnetic emissions associated with data communication via the data transfer bus.

12. A data transfer circuit configured to adjust a frequency spread deviation for spread spectrum clocking of a data transfer via a data transfer bus according to operating conditions of the data transfer circuit, the operating conditions corresponding to data transfer bus loading.

13. A data transfer circuit as recited in claim 12, wherein the operating conditions of the data transfer circuit include at least one of a process, a voltage, and a temperature operating condition.

14. A data transfer circuit as recited in claim 12, wherein the data transfer circuit is further configured to control the frequency spread deviation by adjusting a minimum clock frequency and a maximum clock frequency for the data transfer.

15. A data transfer circuit as recited in claim 12, wherein the data transfer circuit is further configured to control the frequency spread deviation by adjusting a percentage clock frequency deviation from a center frequency for the data transfer.

16. A data transfer circuit as recited in claim 12, wherein the data transfer circuit is further configured to obtain an operating conditions status from a data register, and wherein the data transfer circuit is further configured to adjust the frequency spread deviation according to the operating conditions status.

17. A data transfer circuit as recited in claim 12, wherein the data transfer circuit is further configured to obtain an operating conditions status from a data register, the operating conditions status corresponding to process, voltage, and temperature operating conditions of the data transfer circuit.

18. A data transfer circuit as recited in claim 12, wherein the data transfer circuit includes variable connection drive pads to couple the data transfer bus, and wherein the data transfer circuit is further configured to obtain an operating conditions status from a data register, the operating conditions status varying according to a drive current strength of a variable connection drive pad.

19. A data transfer circuit as recited in claim 12, wherein the data transfer circuit is further configured to adjust the frequency spread deviation to minimize electromagnetic emissions associated with the data transfer via the data transfer bus.

20. A data transfer circuit as recited in claim 12, wherein the data bus is expandable for variable data transfer, and wherein the data transfer circuit is further configured to adjust the frequency spread deviation to minimize electromagnetic emissions associated with the variable data transfer via the data transfer bus.

21. A control system, comprising an application specific integrated circuit (ASIC) and control logic, wherein:
the ASIC is configured to transfer data to a memory component via a memory bus, the ASIC including:
a clocking control configured to control a frequency spread deviation for data transfer via the memory bus; and
a process-voltage-temperature (PVT) status register configured to maintain a PVT status of the ASIC, the PVT status corresponding to memory bus loading;
the control logic is configured to:
obtain the PVT status from the PVT register; and
generate a clocking control input to adjust the frequency spread deviation according to the PVT status.

22. A control system as recited in claim 21, wherein the clocking control is a phase-locked loop configured to receive the clocking control input and adjust the frequency spread deviation.

23. A control system as recited in claim 21, wherein the clocking control is further configured to control the frequency spread deviation by adjusting a minimum clock frequency and a maximum clock frequency for data transfer.

24. A control system as recited in claim 21, wherein the clocking control is further configured to control the frequency spread deviation by adjusting a percentage clock frequency deviation from a center frequency for data transfer.

25. A control system as recited in claim 21, wherein the ASIC further includes variable connection drive pads, and wherein PVT operating conditions of the ASIC vary according to a drive current strength of a variable connection drive pad.

26. A control system as recited in claim 21, wherein the control logic is implemented as firmware in the control system.

27. A control system as recited in claim 21, wherein the control logic is further configured to generate the clocking control input to adjust the frequency spread deviation to minimize electromagnetic emissions associated with data transfer via the memory bus.

28. A method, comprising:
controlling a frequency spread deviation for data transfer to a component via a data transfer bus;
maintaining an operating conditions status that corresponds to data transfer loading on the data transfer bus; and
generating an input to adjust the frequency spread deviation according to the operating conditions status.

29. A method as recited in claim 28, further comprising obtaining the operating conditions status from a data register.

30. A method as recited in claim 28, further comprising:
obtaining the operating conditions status from a data register; and
setting a drive current strength of a variable connection drive pad according to the operating conditions status.

31. A method as recited in claim 28, further comprising adjusting the frequency spread deviation to minimize electromagnetic emissions associated with data transfer via the data transfer bus.

32. A method as recited in claim 28, wherein controlling includes controlling the frequency spread deviation with a phase-locked loop configured to receive the input to adjust the frequency spread deviation.

33. A method as recited in claim 28, wherein controlling includes controlling the frequency spread deviation by adjusting a minimum clock frequency and a maximum clock frequency for the data transfer.

34. A method as recited in claim 28, wherein controlling includes controlling the frequency spread deviation by adjusting a percentage clock frequency deviation from a center frequency for the data transfer.

35. A method as recited in claim 28, wherein the operating conditions status corresponds to at least one of a process, a voltage, and a temperature operating condition.

36. A method, comprising:
controlling a frequency spread deviation for data communication with a memory component via a memory bus;
maintaining a process-voltage-temperature (PVT) status that corresponds to data loading on the memory bus, the PVT status indicating operating conditions of an application specific integrated circuit (ASIC); and
generating an ASIC input to adjust the frequency spread deviation according to the PVT status.

37. A method as recited in claim 36, further comprising obtaining the PVT status from a PVT data register.

38. A method as recited in claim 36, further comprising:
obtaining the PVT status from a PVT data register; and
setting a drive current strength of a variable connection drive pad of the ASIC according to the PVT status.

39. A method as recited in claim 36, further comprising adjusting the frequency spread deviation to minimize electromagnetic emissions associated with data communication via the memory bus.

40. A method as recited in claim 36, wherein controlling includes controlling the frequency spread deviation with a phase-locked loop, the phase-locked loop configured to receive the ASIC input to adjust the frequency spread deviation.

41. A method as recited in claim 36, wherein controlling includes controlling the frequency spread deviation by adjusting a minimum clock frequency and a maximum clock frequency for the data communication.

42. A method as recited in claim 36, wherein controlling includes controlling the frequency spread deviation by adjusting a percentage clock frequency deviation from a center frequency for the data communication.

43. One or more computer-readable media comprising computer executable instructions that, when executed, direct a printing device to:
control a frequency spread deviation for data transfer to a memory component via a memory bus;
maintain a process-voltage-temperature (PVT) status that corresponds to data transfer loading on the memory bus, the PVT status indicating operating conditions of an application specific integrated circuit (ASIC); and
generate an ASIC input to adjust the frequency spread deviation according to the PVT status.

44. One or more computer-readable media as recited in claim 43, further comprising computer executable instructions that, when executed, direct the printing device to obtain the PVT status from a PVT data register.

45. One or more computer-readable media as recited in claim 43, further comprising computer executable instructions that, when executed, direct the printing device to:
obtain the PVT status from a PVT data register; and
set a drive current strength of a variable connection drive pad of the ASIC according to the PVT status.

46. One or more computer-readable media as recited in claim 43, further comprising computer executable instructions that, when executed, direct the printing device to adjust the frequency spread deviation to minimize electromagnetic emissions associated with data transfer via the memory bus.

47. One or more computer-readable media as recited in claim 43, further comprising computer executable instructions that, when executed, direct the printing device to control the frequency spread deviation with a phase-locked loop, the phase-locked loop configured to receive the ASIC input to adjust the frequency spread deviation.

48. One or more computer-readable media as recited in claim 43, further comprising computer executable instructions that, when executed, direct the printing device to control the frequency spread deviation by adjusting a minimum clock frequency and a maximum clock frequency for data transfer.

49. One or more computer-readable media as recited in claim 43, further comprising computer executable instructions that, when executed, direct the printing device to control the frequency spread deviation by adjusting a percentage clock frequency deviation from a center frequency for the data transfer.

50. A data transfer system, comprising:
means to control a frequency spread deviation for data transfer via a data transfer bus;
means to obtain an operating conditions status that corresponds to data transfer loading on the data transfer bus; and
means to generate an input to adjust the frequency spread deviation according to the operating conditions status.

51. A data transfer system as recited in claim 50, further comprising means to maintain the operating conditions status.

52. A data transfer system as recited in claim 50, further comprising means to adjust a drive current strength of a variable connection drive pad according to the operating conditions status.

53. A data transfer system as recited in claim 50, further comprising means to adjust the frequency spread deviation to minimize electromagnetic emissions associated with data transfer via the data transfer bus.
